(19) United States
(12) Patent Application Publication
(10) Pub. No.: US 2026/0160294 A1
(43) Pub. Date: Jun. 11, 2026

(54) ROTATABLE PLUG CONNECTOR ASSEMBLY WITH RADIAL LATCHING

(71) Applicant: Lapp Engineering AG, Cham (CH)

(72) Inventors: Ivica Segrt, Deckenpfronn (DE); Marek Jurak, Zlin (CZ); Siegfried Funk, Lalling (DE)

(73) Assignee: Lapp Engineering AG, Cham (CH)

(21) Appl. No.: 19/410,307

(22) Filed: Dec. 5, 2025

(30) Foreign Application Priority Data
Dec. 10, 2024 (DE) 10 2024 136 911.6

(51) Int. Cl. F16C 11/04

(52) U.S. Cl. CPC F16C 11/04

(57) ABSTRACT

Rotatable plug connector assembly having a first plug element and a second plug element, which comprises a substantially hollow-circular-cylinder-shaped portion. The first plug element and the second plug element can be arranged inside one another at least in part in a connected state and are rotatable relative to one another in the connected state. The substantially hollow-circular-cylinder-shaped portion of the second plug element has latching teeth on the circumference, said latching teeth facing the first plug element in the connected state. In the first plug element there is provided at least one spring element, which comprises at least one spring lugs, which is adapted to engage between two adjacent latching teeth of the second plug element in the connected state.

### CROSS-REFERENCES TO RELATED APPLICATIONS

This application claims the benefit of the German patent application No. 10 2024 136 911.6 filed on Dec. 10, 2024, the entire disclosures of which are incorporated herein by way of reference.

### FIELD OF THE INVENTION

The invention relates to a rotatable plug connector assembly with radial latching, as are used, for example, in angle plug housings, which are fastened to a unit.

### BACKGROUND OF THE INVENTION

Angle plug housings consist of a plug part on the unit side, which is fastened to a unit, and an outlet plug part arranged at an angle thereto. The outlet plug part is arranged so as to be rotatable about the longitudinal axis of the plug part on the unit side. In use, on the one hand it must be possible to change the rotational position of the outlet plug part in order to adapt the angle plug housing to the particular conditions of use, and on the other hand the chosen rotational position must be held securely in such a manner that it is insensitive to vibrations. Consequently, a certain minimum torque must be required in order to rotate the outlet plug part, and secure latching must take place in the chosen rotational position. Secure latching and the minimum torque must also be maintained after a large number of rotation operations.

DE 298 13 455 U1 discloses a rotatable plug connector assembly, which comprises an outer plug part, which is polygonal in cross section along its inner circumference, wherein leaf springs are provided on the polygon faces, and an inner plug part, which is polygonal in cross section along its outer circumference and is arranged in the outer plug part. In a latched position, the polygon faces of the inner plug part lie against the leaf springs. Depending on the chosen spring force, this produces latching with only limited stability. If the two plug parts are rotated relative to one another, outer edges of the inner plug part press against the leaf springs, which causes wear and leads to the inner plug part becoming rounded. As a result of the inner polygonal plug part becoming rounded, the torque required for rotation decreases, and stable latching can thus no longer be ensured. Furthermore, the rotation of the plug parts causes abrasion, which can damage the unit.

EP 1 753 092 A1 discloses a rotatable plug connector assembly, which comprises a first plug element and a second plug element, which is substantially hollow-circular-cylinder-shaped, wherein the first plug element and the second plug element are arranged inside one another at least in part and are rotatable relative to one another, the second plug element has latching teeth on the circumference, said latching teeth facing the first plug element, and a plurality of radially movable latching pins and a plurality of spring elements are arranged in the first plug element, wherein each spring element urges a latching pin radially in the direction towards the latching teeth of the second plug element. Because multiple spring elements and multiple latching pins are provided, assembly of the plug connector assembly is relatively complex. Furthermore, a holding ring is required for axially securing the first and second plug elements, said holding ring being fastened solely by spring pretensioning, which may result in inadequate securing. Furthermore, damage-free disassembly of the plug connector assembly is not possible or is possible only with great effort.

### SUMMARY OF THE INVENTION

An object of the invention is to provide a rotatable plug connector assembly which solves at least one of the problems outlined above and/or a problem associated therewith.

According to the invention, the object is achieved by a rotatable plug connector assembly having a first plug element and a second plug element, which comprises a substantially hollow-circular-cylinder-shaped portion. The first plug element and the second plug element can be arranged inside one another at least in part in a connected state and are rotatable relative to one another in the connected state. The substantially hollow-circular-cylinder-shaped portion of the second plug element has latching teeth on the circumference, said latching teeth facing the first plug element in the connected state. In the first plug element there is provided at least one spring element, which comprises at least one spring lug, which is adapted to engage between two adjacent latching teeth of the second plug element in the connected state.

### Advantages, Embodiment and Further Developments of the Invention

Because the spring element comprises at least one latching lug, no additional pins are required and the number of spring elements required can be reduced (for example to one or two). This can facilitate the production, the assembly and/or the disassembly of the plug connector assembly. In particular damage-free disassembly can be possible. Exchange of the spring element or the spring elements together with the spring lugs, for example in order to change the minimum torque, can also be facilitated.

The at least one spring element may comprise a plurality of spring lugs, each of which is adapted to engage between two adjacent latching teeth of the second plug element in the connected state.

If a spring element comprises a plurality of spring lugs, for example, the number of spring elements can be reduced, thereby saving material and/or manufacturing costs, while maintaining the total number of spring lugs. Furthermore, a relative position and/or alignment of the plurality of spring lugs with respect to each other can be ensured, since the plurality of spring lugs are connected to each other by the common spring element.

In the rotatable plug connector assembly, the first plug element and the second plug element can be so designed that a positive-locking connection of the first plug element and the second plug element in respect of an axially acting force is ensured in the connected state.

In the rotatable plug connector assembly, the second plug element can comprise a holding ring, which comprises a holding portion running in an annular manner and facing radially inwards, said holding portion engaging in the connected state into a groove provided on an outer side of the hollow-circular-cylinder-shaped portion of the second plug element. The holding portion can have, for example, a rectangular cross section or a rectangular cross section with rounded corners. The holding portion can be in the form of an annular projection, which extends radially inwards starting from an annular base portion of the holding ring. The holding ring can thus have, for example, a substantially L-shaped cross section. The holding ring can, however, also be so configured that it has a rectangular cross section. By providing the holding ring and the associated groove, axial latchability is ensured.

The holding ring can be provided either in the form of a fully closed ring or in the form of a ring that is not fully closed, that is to say in the form of a ring with an opening. When the holding ring is provided in the form of a ring with an opening, the radius thereof may optionally be increased slightly in order to insert the second plug element into the first plug element.

In the rotatable plug connector assembly, the engagement of the holding portion into the groove can effect a positive-locking connection of the first plug element and the second plug element in respect of an axially acting force. By overcoming a predetermined minimum axial force, the positive-locking connection can be released and the second plug element can be separated from the first plug element and thus the connected state can be released.

In the rotatable plug connector assembly, the groove can be provided within the latching teeth. The latching teeth can run perpendicular to the groove, wherein the latching teeth run in the axial direction and the groove runs in the circumferential direction. The groove can in particular be so configured that a base portion of the groove lies radially at the same level as a base portion of the gaps between the latching teeth. The groove can, however, also be designed to be deeper or less deep.

The latching teeth, when viewed in the axial direction (i.e. in an insertion direction), can be located on both sides of the groove. In particular, the latching teeth can also be located on a side of the groove that corresponds to an end face of the second plug element. In this case, insertion of the first plug element into the second plug element can be facilitated because the spring lugs are immediately able to slide in the axial direction into the gaps between the latching teeth. Guided connection of the plug connector assembly is thus possible.

In the rotatable plug connector assembly, the first plug element can comprise an O-ring, which runs in an annular manner around the holding ring and is adapted to press the holding ring radially inwards. The O-ring can thus be arranged between a base body of the first plug element and the holding ring. On insertion of the second plug element, the holding ring is pressed radially outwards against the O-ring, which deforms elastically and thus allows an elastic return force to act radially against the holding ring, with the result that the holding ring is able to engage securely in the groove of the second plug element.

In the rotatable plug connector assembly, the first plug element can be open in the axial direction on a side remote from the second plug element in the connected state, so that the holding ring and the O-ring can be removed in the axial direction. Assembly and/or disassembly of the plug connector assembly can thus be facilitated.

In the rotatable plug connector assembly, the first plug element can comprise a flange with screw openings for screwing the first plug element to a flat surface, so that, in a screwed-on state of the first plug element, the O-ring and the holding ring are clamped between the flat surface and the first plug element. The O-ring and the holding ring can thus be held securely in an attached state of the first plug element. Removal of these components is possible by unscrewing the first plug element.

In the rotatable plug connector assembly, exactly one integrally formed spring element can be provided in the first plug element, said spring element comprising the plurality of spring lugs. The plurality of spring lugs can in particular be 2, 3 or 4 spring lugs. When only one integrally formed spring element is provided in the first plug element, assembly and/or disassembly in particular can be facilitated considerably compared to a case where multiple spring elements are provided. When the spring element comprises the plurality of spring lugs, it is not necessary to provide additional pins or latching pins, which can facilitate production, assembly and/or disassembly. In particular in the case where 4 spring lugs are provided, in each case two spring lugs can be arranged opposite one another, so that their radial forces act in opposite directions.

The spring element can be provided, for example, in the form of a fully closed corrugated ring. The spring element can further be provided in the form of a corrugated ring with an opening. In this case, the spring element can be produced, for example, in a simple manner from a metal sheet. In principle, unless explicitly indicated otherwise, the term “ring” or “annular” herein also means a ring that is not closed and thus has an opening. However, a closed ring is of course also meant, unless explicitly excluded.

The first plug element may comprise at least two, and in particular exactly two, spring elements, each of which is formed integral and each of which comprises at least one spring lug. In particular, exactly two spring elements may be provided, each of which comprises exactly two spring lugs. By providing two spring elements (instead of one), material can be saved which would otherwise be needed to connect the two spring elements to form one spring element.

In the rotatable plug connector assembly, the at least one spring lug of the at least one spring element (i.e., of the one spring element or—if present—of the plurality of spring elements) can be adapted to be in direct contact with the latching teeth of the second plug element in the connected state. The at least one spring lug thus touches the latching teeth directly and no additional pins or latching pins are required.

In the rotatable plug connector assembly, the at least one spring element can be in the form of an integrally formed corrugated spring steel sheet, and the at least one spring lug can be formed by bending the spring steel sheet and are thus part of the spring steel sheet. An integral form of the spring steel sheet can facilitate production, assembly and/or disassembly. When the at least one spring lug is formed by bending the spring steel sheet, on the one hand a controlled spring force can be set and on the other hand production of the spring lug(s) is possible in a simple manner.

In the rotatable plug connector assembly, the spring steel sheet can have a constant thickness. In particular, the spring steel sheet in this case has the same thickness in the region of the latching lugs as in the remaining regions of the spring steel sheet. Thickness means a sheet thickness, that is to say a thickness of the spring steel sheet perpendicular to a corrugated surface of the spring steel sheet. When the thickness is constant, the spring steel sheet together with the spring lug(s) can be produced in a simple manner, for example, from a sheet of constant thickness. By replacing the spring element by a spring element of a different thickness, in particular of a different constant thickness, a torque that is required to rotate the plug elements relative to one another can be changed in a simple manner.

In the rotatable plug connector assembly, the at least one spring element can be received under pretensioning in a receiving recess of the first plug element. The receiving recess for the at least one spring lug can have a radial opening through which the respective spring lug projects radially inwards. The pretensioning can serve to ensure that the at least one spring element is received securely in the receiving recess and cannot fall out. The radial opening can comprise an axially extending slot. The radial opening can be substantially rectangular. When only the latching lugs of the spring steel sheet project inwards through their respective opening, secure radial engagement of the second plug element can be ensured, wherein the spring steel sheet is held securely at the same time.

The rotatable plug connector assembly can further comprise a sealing ring, which runs in an annular manner on an inner side of the first plug element and which in the connected state effects sealing between the first plug element and the second plug element. Further sealing rings can be provided. Sealing can in particular prevent the ingress of liquids into the plug connector assembly, or between the two plug elements, and thus ensure reliable operation.

In the rotatable plug connector assembly, the latching teeth of the second plug element can have a substantially trapezoidal cross section. Abrasion of the latching teeth on rotation of the second plug element can thus be reduced and/or rotation can be facilitated.

In the rotatable plug connector assembly, the first plug element and the second plug element can be so configured that, in the connected state, the second plug element is located at least in part inside the first plug element, an outer circumferential surface of the second plug element faces an inner circumferential surface of the first plug element, and the at least one spring lug of the at least one spring element is urged by the at least one spring element radially inwards towards the latching teeth formed on the outer circumference of the second plug element.

When characteristics of the “at least one spring lug” are described herein, this may mean that the respective characteristic applies to the one spring lug as well as to all other spring lugs that may be present. When characteristics of the “at least one spring element” are described herein, this may mean that the respective characteristic applies to the one spring element as well as to all other spring elements that may be present.

### BRIEF DESCRIPTION OF THE DRAWINGS

Exemplary embodiments of the invention will be described in greater detail hereinbelow with reference to the drawings.

FIG. 1 shows a perspective view of a first embodiment of a first plug element of a rotatable plug connector assembly according to the invention;

FIG. 2 shows a perspective view of a first plug element of a further rotatable plug connector assembly according to the invention;

FIG. 3 shows a perspective exploded view of a second embodiment of a first plug element of a rotatable connector assembly according to the invention;

FIG. 4 shows a top view of the first plug element of FIG. 3;

FIG. 5 shows a perspective view of the first plug element of FIG. 3;

FIG. 6 shows a top view of a third embodiment of a first plug element of a rotatable connector assembly according to the invention;

FIG. 7 shows a perspective view of a second plug element of a rotatable plug connector assembly according to the invention;

FIG. 8 shows a sectional view of the cooperation of the first and second plug elements of a rotatable plug connector assembly according to the invention in the connected state; and

FIG. 9 shows a perspective view of a rotatable plug connector assembly according to the invention in the connected state.

### DETAILED DESCRIPTION OF PREFERRED EMBODIMENTS

In the following, spatial relationships, for example top, bottom, inside, outside, etc., are used to graphically describe the exemplary embodiments. The person skilled in the art will appreciate that this serves for graphic description and is not to be interpreted as being a limitation.

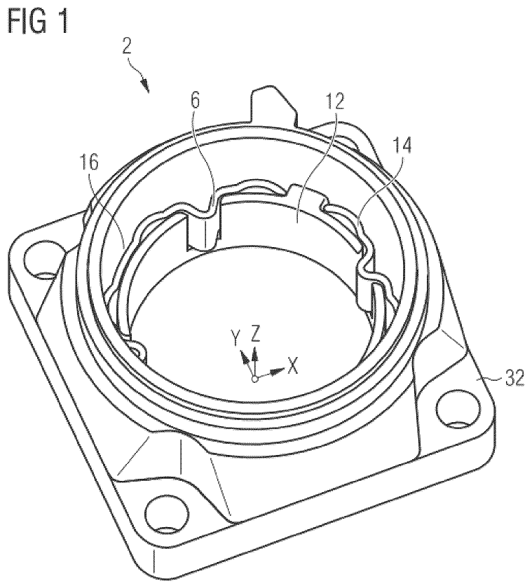

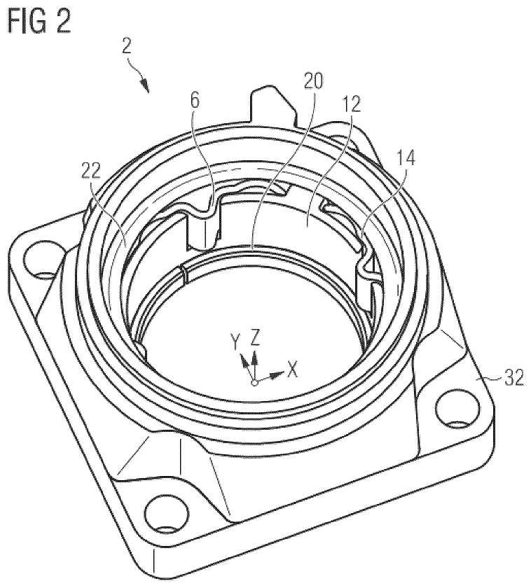

FIG. 1 shows a perspective view of a first embodiment of a first plug element 2 of a rotatable plug connector assembly according to the invention. FIG. 2 likewise shows a perspective view of a first plug element 2 of a rotatable plug connector assembly according to the invention. FIGS. 1 and 2 can either be regarded as different embodiments of plug connector assemblies according to the invention. In this case, the first embodiment of FIG. 1 is one in which the first plug element does not have a holding ring or a sealing ring. The first plug element 1 of the alternative embodiment of FIG. 2, however, has a holding ring 20 and a sealing ring 22. In an alternative point of view, FIG. 1 shows a state of the first plug element 2 of FIG. 2 in which the holding ring 20 and the sealing ring 22 have not yet been fitted and thus, both FIG. 1 and FIG. 2 show the same embodiment.

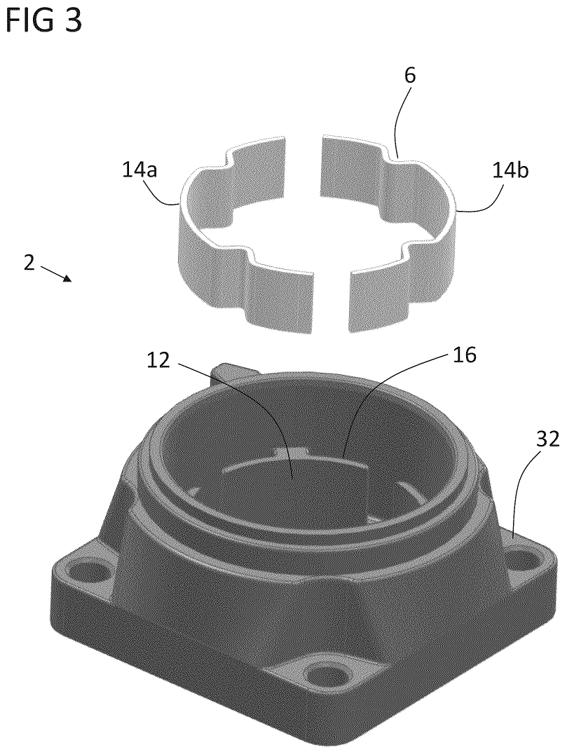

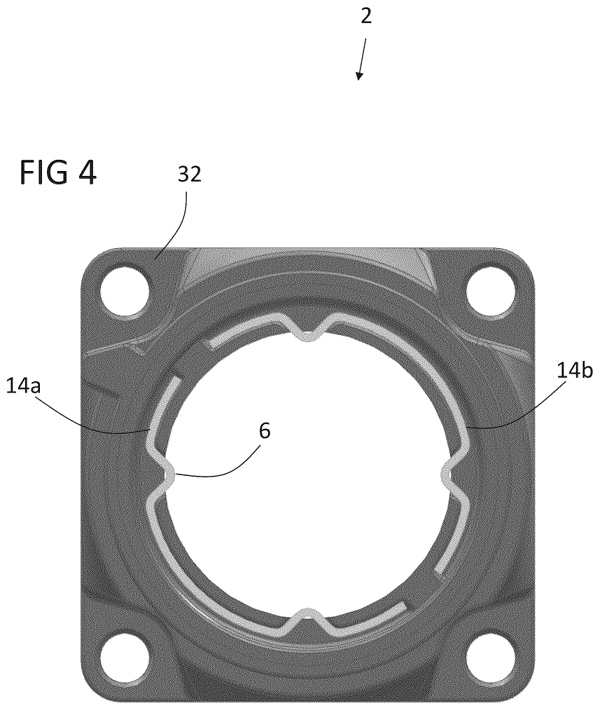

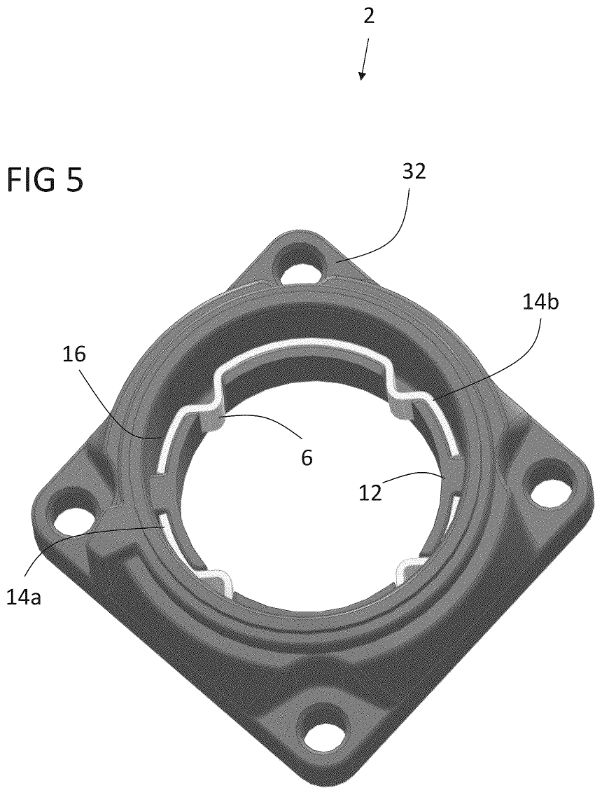

FIGS. 3 to 5 show different views of a second embodiment of a first plug element 2, wherein the essential difference to the first embodiment of the first plug element of FIGS. 1 and 2 is that the first plug element 2 of the second embodiment comprises two spring elements 14a and 14b instead of one spring element 14. Similar to what is shown in FIG. 2, the first plug element 2 of the second embodiment may comprise a holding ring 20 and a sealing ring 22. Since the first plug element 2 of the second embodiment of FIGS. 3 to 5 is otherwise identical to that of the embodiment(s) of FIGS. 1 and 2, the following description of FIGS. 1 and 2 also applies to the second embodiment of FIGS. 3 to 5.

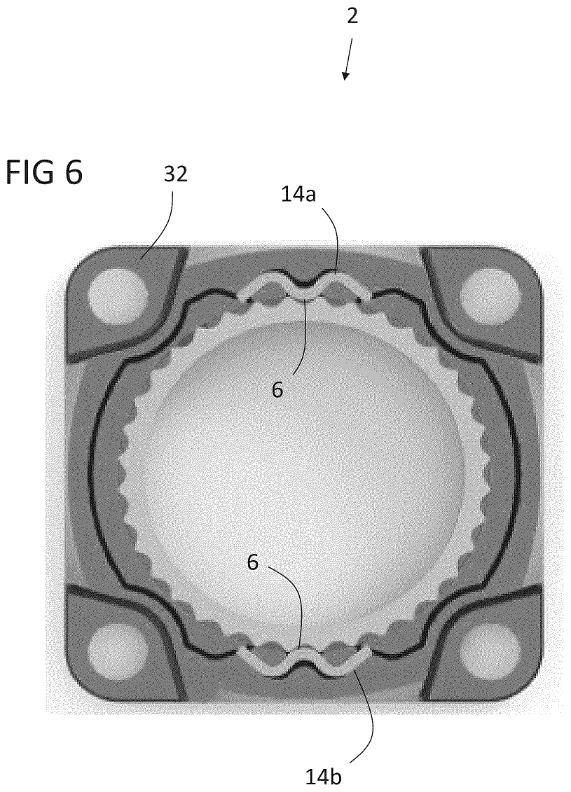

FIG. 6 shows a top view of a third embodiment of a first plug element 2, wherein a common feature with the second embodiment of the first plug element of FIGS. 3 to 5 is that the first plug element 2 of the third embodiment comprises two spring elements 14a and 14b instead of one spring element 14. However, unlike the spring elements 14a and 14b of the second embodiment, the spring elements 14a and 14b of the third embodiment each comprise only one spring lug 6. The two spring elements 14a and 14b are each w-shaped. Similar to what is shown in FIG. 2, the first plug element 2 of the third embodiment may comprise a holding ring 20 and a sealing ring 22. Since the first plug element 2 of the third embodiment of FIG. 6 is otherwise identical to that of the embodiment(s) of FIGS. 1 and 2, the following description of FIGS. 1 and 2 also applies to the third embodiment of FIG. 6.

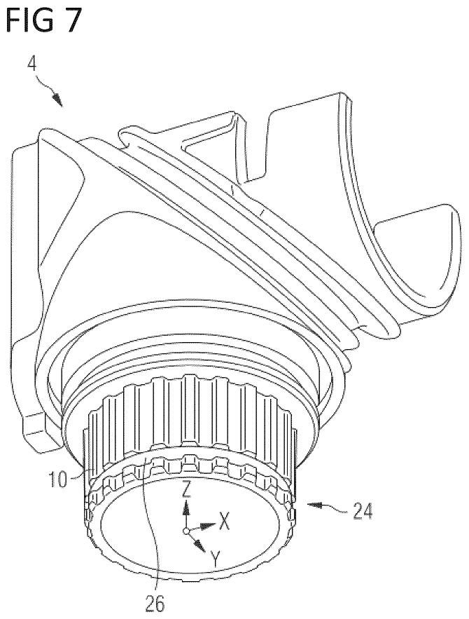

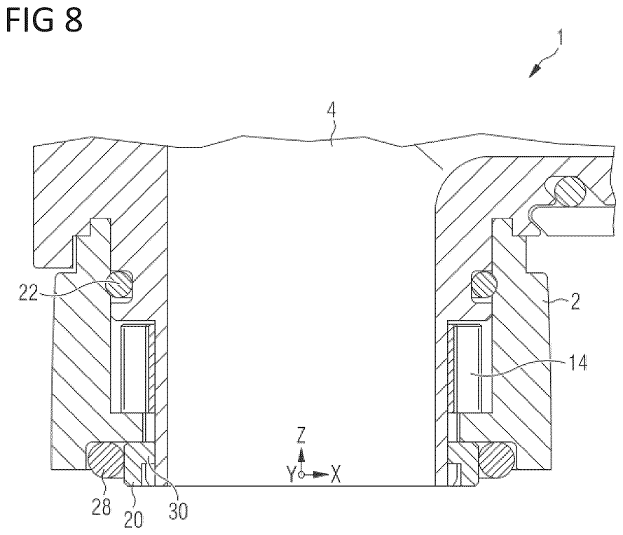

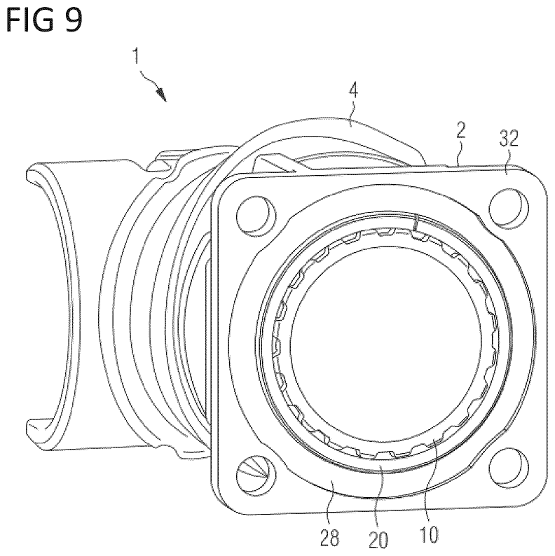

FIG. 7 shows a perspective view of a second plug element 4 of a rotatable plug connector assembly according to the invention. The second plug element 4 is suitable for being inserted in an axial direction (defined herein and according to the figures as the z-direction) into a substantially circular-cylinder-shaped opening of the first plug element 2 according to one of the first to the third embodiments of FIGS. 1 to 6 in order to form a connected state, which is shown, for example, in FIGS. 8 and 9. The second plug element 4 of FIG. 7 forms a housing part of an angle plug of the plug connector assembly. Further elements of the angle plug are assumed to be known and for the sake of clarity are not shown in the figures and are not described herein.

FIGS. 8 and 9 show different views of the plug connector assembly 1 formed of the first plug element 2 of FIG. 2 or one of the first plug elements 2 of FIGS. 3 to 6 and the second plug element 4 of FIG. 7 in the connected state. FIGS. 8 and 9 thus show a rotatable plug connector assembly 1 having the first plug element 2 and the second plug element 4. The second plug element 4 has a substantially hollow-circular-cylinder-shaped portion 24 (see FIG. 7), which defines a radial direction and an axial direction. According to the figures, the axial direction is defined as the z-direction. In the connected state according to FIGS. 8 and 9, the second plug element 4 is arranged inside the first plug element 2.

The second plug element 4 comprises latching teeth 10 of substantially trapezoidal cross section, which in the connected state face the first plug element 2 and extend axially along the outer circumference of the substantially hollow-circular-cylinder-shaped portion 24 of the second plug element 4.

The first plug element 2 of the first embodiment of FIG. 1 or FIG. 2 comprises four spring lugs 6, which are an integral part of a spring element 14. The spring element 14 is in the form of an integrally formed corrugated spring steel sheet.

In the case of the second embodiment shown in FIGS. 3 to 5, the first plug element 2 also comprises a total of four spring lugs 6. However, these are divided between two spring elements 14a, 14b. More specifically, the first plug element 2 of the second embodiment comprises two spring elements 14a, 14b, each of which has two spring lugs 6. The first plug element 2 of the third embodiment according to FIG. 6 comprises a total of two spring lugs 6, each of the two spring elements 14a, 14b comprising one spring lug 6.

The spring lugs 6 are formed by bending the spring steel sheet in the first to the third embodiments and thus are part of the spring steel sheet. The spring element 14, 14a, 14b is arranged in a receiving recess 16 of the first plug element 2, where it is held independently owing to its pretensioning. The receiving recess 16 extends substantially in the circumferential direction around the circular-cylinder-shaped opening of the first plug element 2. Starting from the receiving recess 16, openings are provided at positions of the spring lugs 6, through which openings the spring lugs 6 project in a radial direction relative to a central axis of the circular-cylinder-shaped opening of the first plug element 2. The openings are provided in a frame element 12 of the first plug element 2. The spring element 14, 14a, 14b is pretensioned in such a manner that it urges the latching lugs 6 radially against the second plug element 4. The latching lugs 6 are each elastically deformable independently of one another by a radially acting force.

The number of spring lugs 6 is not limited to four and can be chosen freely as required, wherein at least two spring lugs 6 are advantageous. Furthermore, for example, two integral spring elements 14a and 147b each having two spring lugs 6 can be provided and located in an associated receiving recess 16, as shown according to the second exemplary embodiment of FIGS. 3 to 5. According to the third embodiment shown in FIG. 6, two integral spring elements 14a and 14b, each with a spring lug 6, may be provided and located in an associated receiving recess.

The first plug element 2 is part of a plug part on the unit side (not shown), which can be connected to a unit, and the second plug element 4 is part of an outlet plug part (not shown). The plug part on the unit side and the outlet plug part form the angle plug housing.

If the second plug element 4 is rotated relative to the first plug element 2, the sloping side faces of the substantially trapezoidal latching teeth 10 urge the respective spring lug 6 radially outwards, which generates a counter-force, which acts against the latching tooth 10. The torque required for rotating and unlatching the first plug element 2 is thus produced. The force, or torque, can be specified, for example, by the choice of material of the spring element 14, 14a, 14b and/or by the choice of thickness of the spring element 14, 14a, 14b (i.e. material thickness) and can be changed if required by exchanging the spring element 14 or the spring elements 14a, 14b.

Unlatching takes place with low wear, because plastic deformation does not occur. The spring element 14, 14a, 14b elastically absorbs the radial movement and optionally deformation of the spring lug 6 without plastic deformation of the first plug element 2 or of the second plug element 4 or of the latching teeth 10 occurring.

If the second plug element 4 is rotated further so that the radially outer face, facing the first plug element 2, of the substantially trapezoidal latching tooth 10 touches the spring lug 6, the spring lug 6 is in a position of great radial displacement, and the spring element 14, 14a, 14b reaches a state of higher spring tension. If the second plug element 4 is rotated further, the spring element 14, 14a, 14b, owing to its spring tension, urges the spring lug 6 into a substantially trapezoidal groove (i.e. into a gap) between two latching teeth 10. Reliable latching is thus achieved. Play-free latching can be achieved if the spring lug 6 in its latching position touches the sloping side faces of two substantially trapezoidal latching teeth 10.

In the latched position of the plug connector assembly 1, all the spring lugs 6 are in a latching position between two latching teeth 10, so that secure clamping is achieved. The torque required to rotate the second plug element 4 relative to the first plug element 2 generates, through the spring lugs 6, a force on the latching teeth 10, in order to unlock the spring lugs 6. Since all the spring lugs 6 are moved out of their latching position on unlatching, an unlatching force exerted by a spring lug 6 on the respective latching tooth 10 is relatively low at a given torque, which is required for rotation, because the unlatching force resulting from the torque is divided between a plurality of spring lugs 6 and a plurality of latching teeth 10. Wear can thus be reduced. The latching teeth 10 and the spring lugs 6 extend in an axial direction, so that a wear-reducing larger contact surface, or larger pressing surface, is formed between them. The latching teeth 10 do not necessarily have to extend axially; they can also extend parallel to one another and obliquely relative to the axial direction.

The person skilled in the art will recognise that the substantially trapezoidal profile of the latching teeth 10 can be rounded so as to further minimise wear. Furthermore, the radially outer face of the substantially trapezoidal latching tooth 10 can be reduced, so that an almost rectangular profile of the latching tooth 10 is obtained, as a result of which the spacing of the latching positions is reduced. This form of the latching tooth 10 is considered to be equivalent. By means of the substantially trapezoidal latching teeth 10, it is achieved that the plug connector assembly 1 is insensitive to production tolerances.

Friction and thus the torque can be reduced by a suitable surface coating of the latching teeth 10, the spring lugs 6 and/or the spring elements 14, 14a, 14b. Lubrication can further be provided.

The rotatable plug connector assembly 1 according to the invention has been described such that the second plug element 4 is located in the first plug element 2 and the latching teeth 10 are directed radially outwards. However, the person skilled in the art will recognise that such a rotatable plug connector assembly 1 can also have the reverse construction.

In addition to the above-described radial latching, the plug connector assembly 1 of FIGS. 2 to 9 additionally makes it possible for the second plug element 4 to be latched axially in relation to the first plug element 2. For this purpose, the first plug element 2 has a holding ring 20. The holding ring 20 of the first plug element 2 is adapted to engage into a groove 26 of the second plug element 4 in the connected state. The holding ring 20 of the embodiment shown has an opening, or interruption, which makes it possible or makes it easier for the radius of the holding ring 20 to be changed. By means of an O-ring 28, described hereinbelow, of the first plug element 2, a radially inwardly acting force is exerted on the holding ring 20, which force must be overcome on insertion of the second plug element 4 until the holding ring 20 is able to engage in the groove 26. The inside radius of the holding ring 20 is here increased in the meantime.

As is shown in FIG. 8, the holding ring has a holding portion 30, which runs in an annular manner and faces radially inwards. The holding portion 30 is the portion of the holding ring 20 that is located inside the groove 26 in the connected state. As is shown in FIG. 8, the holding ring 20 can have a substantially L-shaped cross section. The holding portion 30 accordingly has a substantially rectangular cross section with rounded corners.

The engagement of the holding portion 30 into the groove 26 effects a positive-locking connection of the first plug element 2 and the second plug element 4 in respect of an axially acting force. By overcoming a predetermined minimum axial force, the positive-locking connection can be released and the second plug element 4 can be separated from the first plug element 2 and thus the connected state can be released.

For exerting a radial force on the holding ring 20 and for holding the holding ring 20, an O-ring 28 is provided. The O-ring 28 is located between a base body of the first plug element 2 and the holding ring 20.

The first plug element 2 is open in the axial direction on a side remote from the second plug element 4 in the connected state, so that the holding ring 20 and the O-ring 28 can be removed in the axial direction. Assembly and/or disassembly of the plug connector assembly 1 can thus be facilitated.

The first plug element 2 comprises a flange 32 with screw openings for screwing the first plug element 2 to a flat surface, so that, in a screwed-on state of the first plug element 2, the O-ring 28 and the holding ring 20 are clamped between the flat surface and the first plug element 2. The O-ring 28 and the holding ring 20 can thus be held securely in an attached state of the first plug element 2. Removal of these components is possible by unscrewing the first plug element 2.

The rotatable plug connector assembly 1 comprises a sealing ring 22, which runs in an annular manner on an inner side of the first plug element 2 and which in the connected state effects sealing between the first plug element 2 and the second plug element 4. Further sealing rings can be provided. Sealing can in particular prevent the ingress of liquids into the plug connector assembly 1, or between the two plug elements 2, 4, and thus ensure reliable operation.

What is claimed is:

1. Rotatable plug connector assembly having:
a first plug element; and
a second plug element, which comprises a substantially hollow-circular-cylinder-shaped portion,
wherein the first plug element and the second plug element can be arranged inside one another at least in part in a connected state and are rotatable relative to one another in the connected state;
the substantially hollow-circular-cylinder-shaped portion of the second plug element has latching teeth on the circumference, said latching teeth facing the first plug element in the connected state; and
in the first plug element there is provided at least one spring element, which comprises at least one spring lug, which is adapted to engage between two adjacent latching teeth of the second plug element in the connected state.

2. Rotatable plug connector assembly according to claim 1, wherein the at least one spring element comprises a plurality of spring lugs, each of which is adapted to engage between two adjacent latching teeth of the second plug element in the connected state.

3. Rotatable plug connector assembly according to claim 1, wherein the first plug element and the second pug element are so designed that a positive-locking connection of the first plug element and the second plug element in respect of an axially acting force is ensured in the connected state.

4. Rotatable plug connector assembly according to claim 1, wherein the second plug element comprises a holding ring, which comprises a holding portion running in an annular manner and facing radially inwards, said holding portion engaging in the connected state into a groove provided on an outer side of the hollow-circular-cylinder-shaped portion of the second plug element.

5. Rotatable plug connector assembly according to claim 4, wherein the engagement of the holding portion into the groove effects a positive-locking connection of the first plug element and the second plug element in respect of an axially acting force.

6. Rotatable plug connector assembly according to claim 4, wherein the groove is provided within the latching teeth.

7. Rotatable plug connector assembly according to claim 4, wherein the first plug element comprises an O-ring, which runs in an annular manner around the holding ring and is adapted to press the holding ring radially inwards.

8. Rotatable plug connector assembly according to claim 7, wherein the first plug element is open in the axial direction on a side remote from the second plug element in the connected state, so that the holding ring and the O-ring can be removed in the axial direction.

9. Rotatable plug connector assembly according to claim 8, wherein the first plug element comprises a flange with screw openings for screwing the first plug element to a flat surface, so that, in a screwed-on state of the first plug element, the O-ring and the holding ring are clamped between the flat surface and the first plug element.

10. Rotatable plug connector assembly according to claim 2, wherein exactly one integrally formed spring element is provided in the first plug element, said spring element comprising the plurality of spring lugs, wherein the plurality of spring lugs is in particular 2, 3, or 4 spring lugs.

11. Rotatable plug connector assembly according to claim 1, wherein at least two and in particular exactly two integrally formed spring elements are provided in the first plug element, said spring elements each comprising at least one spring lug.

12. Rotatable plug connector assembly according to claim 1, wherein the at least one spring element is in the form of an integrally formed corrugated spring steel sheet, in particular of constant thickness, and the at least one spring lug is formed by bending the spring steel sheet and thus are part of the spring steel sheet.

13. Rotatable plug connector assembly according to claim 1, wherein the at least one spring element is received under pretensioning in a receiving recess of the first plug element, and wherein the receiving recess for the at least one spring lug has a radial opening through which the spring lug projects radially inwards.

14. Rotatable plug connector assembly according to claim 1, further comprising a sealing ring, which runs in an annular manner on an inner side of the first plug element and which in the connected state effects sealing between the first plug element and the second plug element.

15. Rotatable plug connector assembly according to claim 1, wherein the first plug element and the second plug element are so configured that, in the connected state, the second plug element is located at least in part in the first plug element, an outer circumferential surface of the second plug element faces an inner circumferential surface of the first plug element, and the at least one spring lug of the at least one spring element is urged by the at least one spring element radially inwards against the latching teeth formed on the outer circumference of the second plug element.
